(19) United States
(12) Patent Application Publication
(10) Pub. No.: US 2019/0347119 A1
(43) Pub. Date: Nov. 14, 2019

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/405,083

(22) Filed: May 7, 2019

(30) Foreign Application Priority Data
May 14, 2018 (JP) 2018-093153

(51) Int. Cl. G06F 9/451; G06F 3/0484; G10L 13/04

(52) U.S. Cl. CPC G06F 9/454; G10L 13/043; G06F 3/0484

(57) ABSTRACT

An information processing apparatus includes a controller that, in a case in which a language setting of a terminal operated by a user and a language setting of a piece of equipment used by being connected to the terminal are different, changes the language of the piece of equipment to the language setting of the terminal.

### CROSS-REFERENCE TO RELATED APPLICATIONS

This application is based on and claims priority under 35 USC 119 from Japanese Patent Application No. 2018-093153 filed May 14, 2018.

### BACKGROUND

### (i) Technical Field

The present disclosure relates to an information processing apparatus, an information processing system, and a non-transitory computer readable medium.

### (ii) Related Art

In some cases, a language setting is changed in a piece of equipment. For example, a user performs an operation on a screen of the equipment to thereby change a setting regarding the language in which to express character strings displayed on the screen.

Japanese Unexamined Patent Application Publication No. 2017-10377 describes an information processing system that includes operating equipment and operated equipment that acts as the target of operation by the operating equipment. In the information processing system, language information about a first language setting that expresses a language setting of a screen display of the operating equipment is transmitted from the operating equipment to the operated equipment. In the case in which the language of the first language setting is settable in a screen display of the operated equipment, the language of a second language setting that expresses a language setting of the screen display of the operated equipment is set to the language of the first language setting.

Japanese Unexamined Patent Application Publication No. 2006-65520 describes a system including a terminal apparatus and a server connected to the terminal apparatus over a network. In the system, the terminal apparatus acquires, from the server, information that identifies a language for expressing data, switches a display language on the basis of the information, and causes a display to display data transmitted from the server.

### Summary

Aspects of non-limiting embodiments of the present disclosure relate to changing the language setting of a piece of equipment easily.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a controller that, in a case in which a language setting of a terminal operated by a user and a language setting of a piece of equipment used by being connected to the terminal are different, changes the language of the piece of equipment to the language setting of the terminal.

### BRIEF DESCRIPTION OF THE DRAWINGS

Exemplary embodiments of the present disclosure will be described in detail based on the following figures, wherein:

FIG. 1 is a block diagram illustrating a configuration of an information processing system according to an exemplary embodiment of the present disclosure;

FIG. 2 is a block diagram illustrating a configuration of a piece of equipment;

FIG. 3 is a block diagram illustrating a configuration of a terminal apparatus;

FIG. 4 is a block diagram illustrating a configuration of a server;

FIG. 5 is a perspective view illustrating a relay;

FIG. 6 is a diagram illustrating a screen;

FIG. 7 is a diagram illustrating an equipment management table;

FIG. 8 is a diagram illustrating a user management table;

FIG. 9 is a diagram illustrating a screen;

FIG. 10 is a diagram illustrating a piece of equipment; and

FIG. 11 is a block diagram illustrating a configuration of an information processing system according to Modification 6.

### DETAILED DESCRIPTION

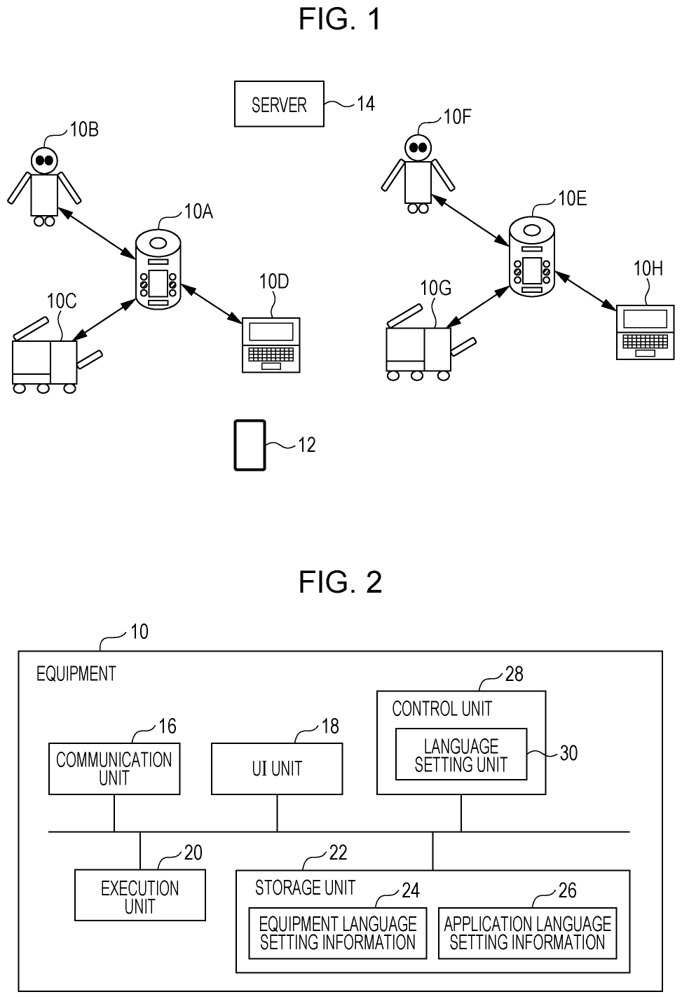

An information processing system according to an exemplary embodiment of the present disclosure will be described with reference to FIG. 1. FIG. 1 illustrates an example of the information processing system according to the exemplary embodiment. As one example, the information processing system includes equipment 10A to 10H, a terminal apparatus 12, and a server 14. Hereinafter, each piece of equipment will be designated the “equipment 10” when the pieces of equipment are not being distinguished individually. Note that the equipment 10A to 10H is merely one example, and it is sufficient for the information processing system to include one or multiple pieces of equipment.

The equipment 10 includes a function of communicating with other equipment 10. The communication may be wireless communication or wired communication. For example, each piece of equipment 10 may communicate with another piece of equipment 10 through a communication pathway such as the Internet or another network, communicate with another piece of equipment 10 directly, communicate with another piece of equipment 10 through a relay that functions as a hub, or communicate with another piece of equipment 10 through what is called the cloud or a server. Each piece of equipment 10 may also be what is called Internet of Things (IoT) equipment.

Also, the equipment 10 is an apparatus having a function, and is an apparatus such as, for example, an image forming apparatus including image forming functions (such as a scan function, a print function, a copy function, and a facsimile function), a personal computer (PC), a tablet PC, a smartphone, a mobile phone, a robot (such as a humanoid robot, a non-human animal-type robot, or some other type of robot), a projector, a display apparatus such as a liquid crystal display, a recording apparatus, a playback apparatus, an imaging apparatus such as a camera, a refrigerator, a rice cooker, a microwave oven, a coffee maker, a vacuum cleaner, a washing machine, an air conditioner, lighting equipment, a clock, a surveillance camera, an automobile, a motorcycle, an aircraft (for example, an unmanned aircraft (also called a drone)), a game console, various types of sensing equipment (such as a temperature sensor, a humidity sensor, a voltage sensor, or a current sensor, for example), and the like. The equipment 10 may be equipment that outputs information to a user (such as an image forming apparatus or a PC, for example), or may be equipment that does not output information to the user (for example, sensing equipment). Also, all equipment 10 among the multiple pieces of equipment 10 that execute a link function described later may be equipment that outputs information to the user, or alternatively, some equipment 10 may be equipment that outputs information to the user while other equipment 10 is equipment that does not output information to the user, or alternatively, all equipment 10 may be equipment that does not output information to the user. Equipment in general may also be included in the conceptual category of the equipment 10. For example, information equipment, video equipment, audio equipment, and other types of equipment may be included in the conceptual category of the equipment 10.

In the example illustrated in FIG. 1, the pieces of equipment 10A and 10E are relays. The pieces of equipment 10B and 10F are robots. The pieces of equipment 10C and 10G are multi-function devices including an image forming function. The pieces of equipment 10D and 10H are PCs.

Also, the pieces of equipment 10A to 10D are installed in Japan, while the pieces of equipment 10E to 10H are installed in the United States of America. For example, the pieces of equipment 10B to 10D are connected to the piece of equipment 10A that acts as a relay, such that an information processing system is constructed by the pieces of equipment 10A to 10D. Similarly, the pieces of equipment 10F to 10H are connected to the piece of equipment 10E that acts as a relay, such that an information processing system is constructed by the piece of equipment 10E to 10H. Obviously, each piece of equipment does not have to be connected to a relay.

The terminal apparatus 12 is a piece of equipment such as a PC, a tablet PC, a smartphone, or a mobile phone. The terminal apparatus may also be a wearable terminal (such as a wristwatch-style terminal, a wristband-style terminal, an eyeglasses-style terminal, a ring-style terminal, a contact lens-style terminal, a body implant-style terminal, or a bearable terminal). Additionally, the terminal apparatus may also include a flexible display as a display apparatus. As the flexible display, for example, an organic electroluminescence display (flexible organic EL display), an electronic paper display, a flexible liquid crystal display, or the like is used. A flexible display adopting a display method other than the above may also be used. A flexible display is a display whose display portion is flexibly deformable, and is a display which may be curved, folded, rolled, twisted, or stretched, for example. The entire terminal apparatus may be configured as a flexible display, or the flexible display and the rest of the configuration may be divided functionally or physically.

The server 14 is an apparatus that stores data, provides software, and provides services, for example. Note that the information processing system according to the exemplary embodiment does not have to include the server 14.

In the exemplary embodiment, in the case in which a language setting of the terminal apparatus 12 and a language setting of a piece of equipment 10 used by being connected to the terminal apparatus 12 are different, the language setting of the piece of equipment 10 is changed to the language setting of the terminal apparatus 12.

The language setting of the equipment 10 is a setting regarding the language used in a user interface of the equipment 10. For example, in the case in which a display is used as the user interface, the language setting of the equipment 10 is a setting regarding the language used to express character strings (for example, character strings indicating the contents of various settings, menus, messages, times and dates, and the like) displayed on the display. In the case in which a speech output unit is used as the user interface, the language setting of the equipment 10 is a setting regarding the language used to express speech emitted from the speech output unit. Note that the language used to display character strings and the language used to produce speech may be the same or different. In other words, the language for displaying character strings and the language for producing speech may be set separately. In the following description, with regard to the equipment 10, the language for displaying character strings and the language for producing speech are assumed to be the same.

The language setting of the equipment 10 is a language setting of an operating system (OS) installed in the equipment 10, for example. The OS is a program that controls and manages the basic operations of the equipment 10. For example, in the case in which the OS language of the equipment 10 is set to Japanese, character strings displayed by the equipment 10 and speech emitted from the equipment 10 are expressed in Japanese.

Additionally, a language may also be set for each piece of application software installed in the equipment 10. A piece of application software is a program by which the equipment 10 executes a function. The language setting of the OS and the language setting of each piece of application software may be the same or different. For example, Japanese may be set as the OS language, while Japanese or English may be set as the language of a certain piece of application software. Also, Japanese may be set in a certain piece of application software, while English may be set in a different piece of application software.

In the case in which a piece of application software is executed, and a screen (such as a settings screen or an operation screen, for example) of the application software is displayed on the equipment 10, character strings displayed on the screen may be expressed in the language set in the application software. The same also applies to produced speech. For example, even in the case in which the OS language of the equipment 10 is set to Japanese, if the application software language is set to English, character strings displayed on the screen of the application software may be expressed in English.

Note that in the case in which a language is not set in a piece of application software, character strings displayed on the screen of the application software are expressed in the OS language of the equipment 10. The same also applies to produced speech.

The language setting of the equipment 10 may also be changed by the user. For example, data for multiple languages is stored in the equipment 10, and a language selected by the user from among the multiple languages is set as the language of the equipment 10. For example, the OS language of the equipment 10 is set by the user. Additionally, the language of application software installed in the equipment 10 may also be set by the user. Language data not stored in the equipment 10 may be downloaded to the equipment 10, or stored in the equipment 10 via a recording medium.

The OS language of the equipment 10 and the language of each piece of application software may also be set individually for each user account.

The language setting of the terminal apparatus 12 is a setting regarding the language used in a user interface of the terminal apparatus 12. For example, in the case in which a display is used as the user interface, the language setting of the terminal apparatus 12 is a setting regarding the language used to express character strings (for example, character strings indicating the contents of various settings, menus, messages, times and dates, and the like) displayed on the display. In the case in which a speech output unit is used as the user interface, the language setting of the terminal apparatus 12 is a setting regarding the language used to express speech emitted from the speech output unit. Note that, similarly to the equipment 10, the language used to display character strings and the language used to produce speech may be the same or different. In other words, the language for displaying character strings and the language for producing speech may be set separately. In the following description, with regard to the terminal apparatus 12, the language for displaying character strings and the language for producing speech are assumed to be the same.

The language setting of the terminal apparatus 12 is a language setting of an OS installed in the terminal apparatus 12 (the language setting of the terminal apparatus 12 itself), for example. The OS is a program that controls and manages the basic operations of the terminal apparatus 12. For example, in the case in which the OS language of the terminal apparatus 12 is set to Japanese, character strings displayed by the terminal apparatus 12 and speech emitted from the terminal apparatus 12 are expressed in Japanese.

Also, in the case in which application software for operating the equipment 10 is installed in the terminal apparatus 12, a language may be set for each piece of application software. Settings regarding the operation of the equipment 10 and functions made to be executed in the equipment 10 may be set by the application software. The language setting of the OS and the language setting of each piece of application software may be the same or different. For example, Japanese may be set as the OS language, while Japanese or English may be set as the language of a certain piece of application software. Also, Japanese may be set in a certain piece of application software, while English may be set in a different piece of application software.

The application software for operating the equipment 10 may be pre-installed in the terminal apparatus 12, or downloaded to the terminal apparatus 12 when using the equipment 10.

In the case in which a piece of application software is executed, and a screen (such as a settings screen or an operation screen, for example) of the application software is displayed on the terminal apparatus 12, character strings displayed on the screen may be expressed in the language set in the application software. The same also applies to produced speech. For example, even in the case in which the OS language of the terminal apparatus 12 is set to Japanese, if the application software language is set to English, character strings displayed on the screen of the application software may be expressed in English.

Note that in the case in which a language is not set in a piece of application software, character strings displayed on the screen of the application software are expressed in the OS language of the terminal apparatus 12. The same also applies to produced speech.

The language setting of the terminal apparatus 12 may also be changed by the user. For example, data for multiple languages is stored in the terminal apparatus 12, and a language selected by the user from among the multiple languages is set as the language of the terminal apparatus 12. For example, the OS language of the terminal apparatus 12 is set by the user. Additionally, the language of application software installed in the terminal apparatus 12 may also be set by the user. Language data not stored in the terminal apparatus 12 may be downloaded to the terminal apparatus 12, or stored in the terminal apparatus 12 via a recording medium.

The OS language of the terminal apparatus 12 and the language of each piece of application software may also be set individually for each user account.

For example, assume that the language (for example, the OS language) of the pieces of equipment 10A to 10D is set to Japanese, the language (for example, the OS language) of the pieces of equipment 10E to 10H is set to English, and the language (for example, the OS language) of the terminal apparatus 12 is set to Japanese. Note that it is assumed that a language has not been set for each piece of application software.

In the case in which the terminal apparatus 12 connects to the equipment 10A, since the language setting of the equipment 10A and the language setting of the terminal apparatus 12 are the same setting of Japanese, the language setting of the equipment 10A is not changed. In other words, character strings displayed on the equipment 10A and speech emitted from the equipment 10A are expressed in Japanese. The same also applies to the case of the terminal apparatus 12 connecting to any of the pieces of equipment 10B to 10D.

On the other hand, in the case in which the terminal apparatus 12 connects to the equipment 10E, since the language setting of the equipment 10E and the language setting of the terminal apparatus 12 are different, the language setting of the equipment 10E is changed. In other words, the language setting of the equipment 10E is changed from the English setting to the Japanese setting. As a result, character strings displayed on the equipment 10E and speech emitted from the equipment 10E are expressed in Japanese. For example, the language of the terminal apparatus 12 is used as the language of the equipment 10E while the terminal apparatus 12 is connected to the equipment 10E, while the equipment 10E is being used via the terminal apparatus 12, or while a process assigned to the equipment 10E via the terminal apparatus 12 is being executed. In the case in which the use of the equipment 10E by the terminal apparatus 12 ends (for example, in the case in which the terminal apparatus 12 and the equipment 10E are disconnected, the case in which the user logs out of the equipment 10E, the case in which the connection is broken due to a timeout, the case in which an assigned process is completed, or the like), the language setting of the equipment 10E is returned to the original language setting. In other words, character strings displayed on the equipment 10E and speech emitted from the equipment 10E are expressed in English.

The process of changing the language setting may be executed by the equipment 10, by the terminal apparatus 12, or by the server 14.

Hereinafter, the information processing system according to the present exemplary embodiment will be described in further detail.

The configuration of a piece of equipment 10 will be described in detail with reference to FIG. 2. FIG. 2 illustrates an example of the configuration of a piece of equipment 10. Note that FIG. 2 illustrates a configuration shared in common among the pieces of equipment 10, and does not illustrate components specific to each piece of equipment 10.

The communication unit 16 is a communication interface, and includes a function of transmitting data to other apparatus, and a function of receiving data from other apparatus. The communication unit 16 may be a communication interface including a wireless communication function, or a communication interface including a wired communication function. For example, the communication unit 16 may support one or multiple types of communication schemes, and may communicate with a communication peer in accordance with a communication scheme suited to the communication peer (in other words, a communication scheme supported by the communication peer). The communication schemes are, for example, infrared communication, visible-light communication, Wi-Fi (registered trademark) communication, short-range wireless communication (such as near field communication (NFC), for example), and the like. As the short-range wireless communication, Felica (registered trademark), Bluetooth (registered trademark), radio-frequency identification (RFID), or the like is used. In addition, the communication unit 16 may also support a 5th generation mobile communication system (5G). Obviously, wireless communication of a different scheme may also be used as the short-range wireless communication. The communication unit 16 may switch the communication scheme and frequency band depending on the communication peer, and may also switch the communication scheme and the frequency band depending on the surrounding environment. For the frequency band, a band such as 2.4 GHz or 5 GHz may be used, for example.

The UI unit 18 is a user interface, and includes a display and an operating unit. The display is a display apparatus such as a liquid crystal display, for example. The display may also be a flexible display. The operating unit is an input apparatus such as a touch panel or a keyboard, for example. The UI unit 18 may also be a user interface combining a display and an operating unit (for example, a touchscreen display, including an apparatus or the like that displays a keyboard or the like electronically on a display). Additionally, the UI unit 18 may also include a sound collector, such as a microphone, and a sound emitter, such as a speaker. In this case, information may also be input into the equipment 10 by speech, and information may also be emitted as speech. Note that a piece of equipment 10 that does not include the UI unit 18 may also be included in the information processing system. For example, sensing equipment that does not output information to the user may not include the UI unit 18 in some cases.

The execution unit 20 is configured to execute functions. For example, in the case in which the piece of equipment 10 is an image forming apparatus, the execution unit 20 executes image forming functions. Also, in the case in which the piece of equipment 10 is a robot, the execution unit 20 executes functions included in the robot (such as a movement function and a pick-up function, for example). In the case in which the piece of equipment 10 is a camera, the execution unit 20 executes an imaging function.

The storage unit 22 is a storage apparatus such as a hard disk or memory (such as an SSD, for example). The storage unit 22 stores various data, various programs, and the like, for example. The stored programs include an OS, various types of application software, various language data, and the like, for example. Depending on the piece of equipment 10, an OS may not be stored in the storage unit 22 in some cases. Also, depending on the piece of equipment 10, application software may not be stored in the storage unit 22 in some cases. The storage unit 22 may also store equipment address information (such as an IP address and a MAC address, for example) indicating the address of another piece of equipment 10, terminal address information (such as an IP address and a MAC address, for example) indicating the address of the terminal apparatus 12, server address information (such as an IP address and a MAC address, for example) indicating the address of the server 14, and the like. Additionally, the storage unit 22 stores equipment language setting information 24 and application language setting information 26.

The equipment language setting information 24 is information indicating the OS language setting of the piece of equipment 10. For example, in the case in which the OS language of the piece of equipment 10 is set to Japanese, the equipment language setting information 24 indicates Japanese.

The application language setting information 26 is information indicating the language setting of each piece of application software installed in the piece of equipment 10. For example, one or multiple pieces of application software are installed in the piece of equipment 10, and a language is set for each piece of application software. Note that in the case in which a language is not set for application software, the application language setting information 26 does not have to be stored in the storage unit 22.

The control unit 28 is configured to control the operation of each unit of the piece of equipment 10. For example, the control unit 28 executes programs, controls communication by the communication unit 16, controls the notification of information (such as the display and sound output of information, for example) using the UI unit 18, receives information input into the piece of equipment 10 using the UI unit 18, controls processing by the execution unit 20, writes information to the storage unit 22, reads out information from the storage unit 22, and the like. Also, the control unit 28 includes a language setting unit 30.

The language setting unit 30 is configured to set the language of the user interface of the piece of equipment 10. The language setting unit 30 causes the storage unit 22 to store the equipment language setting information 24 indicating the OS language setting of the piece of equipment 10, and causes the storage unit 22 to store the application language setting information 26 indicating the language setting of each piece of application software installed in the piece of equipment 10. For example, in the case in which the user uses the UI unit 18 to designate the language of the piece of equipment 10, the language setting unit 30 sets the language of the piece of equipment 10 to the language designated by the user. In the case in which the user designates the OS language of the piece of equipment 10, the language setting unit 30 sets the OS language of the piece of equipment 10 to the language designated by the user. In this case, the equipment language setting information 24 indicating the language designated by the user is stored in the storage unit 22. In the case in which the user designates the language of a piece of application software, the language setting unit 30 sets the language of the piece of application software to the language designated by the user. In this case, the application language setting information 26 indicating the language designated by the user is stored in the storage unit 22.

In addition, in the case in which the language setting of the terminal apparatus 12 that has connected to the piece of equipment 10 is different from the language setting of the piece of equipment 10 itself, the language setting unit 30 changes the language setting of the piece of equipment 10 itself to the language setting of the terminal apparatus 12. For example, in the case in which the OS language setting of the terminal apparatus 12 is different from the OS language setting of the piece of equipment 10 itself, the language setting unit 30 changes the OS language of the piece of equipment 10 itself to the OS language setting of the terminal apparatus 12. Also, in the case in which the terminal apparatus 12 has connected to the piece of equipment 10 itself, and a piece of application software for operating the piece of equipment 10 itself is installed in the terminal apparatus 12 with a different language setting than the language setting of a piece of application software installed in the piece of equipment 10 itself, the language setting unit 30 may change the language setting of the piece of application software installed in the piece of equipment 10 itself to the language setting of the piece of application software for operating the piece of equipment 10 itself installed in the terminal apparatus 12.

For example, the control unit 28 expresses character strings displayed on the display of the UI unit 18 and expresses speech emitted from the speech output unit of the UI unit 18 in the language (that is, the OS language) indicated by the equipment language setting information 24. To describe by giving a specific example, in the case in which the language indicated by the equipment language setting information 24 is Japanese, the control unit 28 expresses character strings and speech in Japanese. For example, character strings displayed on a main screen, character strings displayed on a menu screen, character strings displayed on a settings screen, character strings displayed on an operating screen, various messages, file names, and folder names are expressed in Japanese. In the case in which the language of a piece of application software is not set, character strings displayed in association with the execution of the application software are expressed in the OS language, namely Japanese. The same also applies to speech.

Also, in the case in which the language of a piece of application software is set, when the application software is executed and a screen (such as a settings screen and an operating screen, for example) of the application software is displayed on the UI unit 18, the control unit 28 expresses character strings displayed on the screen in the language of the application software indicated by the application language setting information 26. For example, in the case in which the language set in the application software is English, the control unit 28 expresses character strings displayed on the screen in English. The same also applies to speech.

Note that the piece of equipment 10 may execute a lone function, or execute a link function by linking with another piece of equipment 10. A lone function is a function that is executable using a single piece of equipment 10, for example. A link function is a function that is executable using multiple pieces of equipment 10, for example. In lone functions and link functions, hardware of software included in the equipment 10 are used, for example. Note that in the case in which a piece of equipment 10 does not link with another piece of equipment 10, the piece of equipment 10 may receive an instruction from the user and execute a lone function independently. Obviously, a piece of equipment 10 (for example, sensing equipment) that executes a function without receiving an instruction from the user may also be included in the information processing system.

Link functions will now be described. An entire piece of equipment 10, a specific part of a piece of equipment 10, a specific function of a piece of software, a set of functions including multiple functions, or the like may also be used as a link function. For example, in the case in which a function is assigned to each part of a piece of equipment 10, a link function may be a function that uses the parts. To describe by giving a specific example, assume that a print function is assigned to a main unit of a multi-function device that includes multiple image forming functions, a scan function is assigned to a reading unit (for example, the part corresponding to a document cover, a document glass, or an automatic document feeder) of the multi-function device, and a post-processing function (such as a stapler function, for example) is assigned to a post-processing apparatus of the multi-function device. In this case, the main unit, the reading unit, and the post-processing apparatus of the multi-function device may be used in a link function. Also, as for software, sets of functions collected into block units, such as robotics process automation (RBA) or the like, may be used in a link function. Also, in the case in which a piece of software includes multiple functions, a link function may be a function that uses a subset of the multiple functions. A set of functions includes multiple functions, and by executing the multiple functions simultaneously or successively, a process according to the set of functions is executed. Also, a link function may be a function that uses only hardware, a function that uses only software, or a function that uses both hardware and software.

A link function may be a function that is executable by linking multiple pieces of equipment 10 of different types, or a function that is executable by linking multiple pieces of equipment 10 of the same type. A link function may also be a function which is unusable before linkage. For example, by linking a piece of equipment 10 (printer) including a print function and a piece of equipment 10 (scanner) including a scan function, it becomes possible to execute a copy function as the link function. In other words, by linking the print function and the scan function, the copy function becomes executable.

The conceptual category of a link function may also include a combined function that links multiple pieces of equipment 10 to enable the execution of a new function. For example, by combining multiple displays, an expanded display function may be realized as a combined function. As another example, by combining a TV and a recorder, a video recording function may be realized as a combined function. The video recording function is a function that records images displayed on the TV, for example. Also, by combining multiple cameras, an imaging region expansion function may be realized as a combined function. This expansion function is a function of capturing an image by stitching together the imaging regions of the cameras, for example. Also, by combining a telephone with a translation device or translation software, a telephony translation function (a function whereby a conversation over the phone is translated) may be realized as a combined function. In this way, the conceptual category of a link function may also include functions that are achievable by linking multiple pieces of equipment 10 of the same type, functions that are achievable by linking multiple pieces of software of the same type, functions that are achievable by linking multiple pieces of equipment 10 of different types, and functions that are achievable by linking multiple pieces of software of different types.

In addition, a connected home (a system in which IoT technology is used to interconnect pieces of equipment 10 such as home appliances over a network) may be constructed by multiple pieces of equipment 10, and link functions may be used in the connected home. In this case, the pieces of equipment 10 may be interconnected by going through a specific server, or the pieces of equipment 10 may be interconnected without going through a specific server.

Additionally, multiple pieces of equipment 10 may execute a link function by linking using If This Then That (IFTTT). In other words, the content of the link function is such that when a phenomenon acting as a trigger occurs in a certain piece of equipment 10, another piece of equipment 10 executes an action (process). For example, a link function may be executed in which the detection of a door opening by a sensor serving as a piece of equipment 10 acts as a trigger to execute an action of turning on an illumination apparatus serving as a different piece of equipment 10. Also, a function in which an action by a certain piece of equipment 10 acts as a different trigger by which yet another piece of equipment 10 executes an action may also be included in the conceptual category of a link function. Also, a function that links multiple web services or an application programming interface (API) link that links multiple systems, services, and the like by utilizing an API may also be included in the conceptual category of a link function.

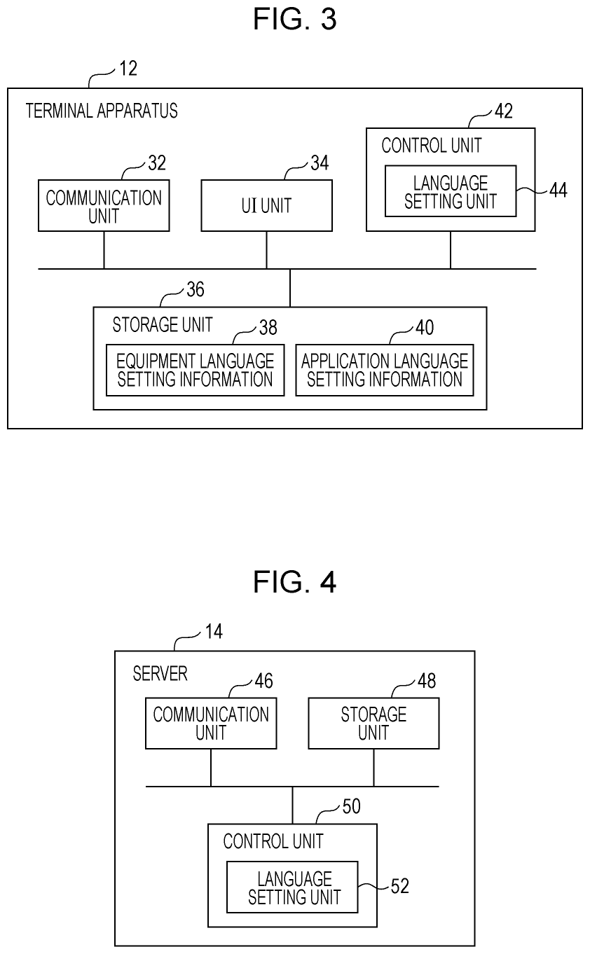

Hereinafter, a configuration of the terminal device 12 will be described in detail with reference to FIG. 3. FIG. 3 illustrates an example of the configuration of the terminal apparatus 12.

The communication unit 32 is a communication interface, and includes a function of transmitting data to other apparatus, and a function of receiving data from other apparatus. The communication unit 32 may be a communication interface including a wireless communication function, or a communication interface including a wired communication function. For example, the communication unit 32 may support one or multiple types of communication schemes, and may communicate with a communication peer in accordance with a communication scheme suited to the communication peer (in other words, a communication scheme supported by the communication peer). For the communication schemes, the communication schemes described above are used, for example. The communication unit 32 may switch the communication scheme and frequency band depending on the communication peer, and may also switch the communication scheme and the frequency band depending on the surrounding environment.

The UI unit 34 is a user interface, and includes a display unit and an operating unit. The display is a display apparatus such as a liquid crystal display, for example. The display may also be a flexible display. The operating unit is an input apparatus such as a touch panel or a keyboard, for example. The UI unit 34 may also be a user interface combining a display and an operating unit. Additionally, the UI unit 18 may also include a sound collector and a sound emitter. In this case, information may also be input into the terminal apparatus 12 by speech, and information may also be emitted as speech.

The storage unit 36 is a storage apparatus such as a hard disk. The storage unit 36 stores various data, various programs, and the like, for example. The stored programs include an OS, various types of application software, various language data, and the like, for example. The storage unit 36 may also store equipment address information (such as an IP address and a MAC address, for example) indicating the address of a piece of equipment 10, terminal address information (such as an IP address and a MAC address, for example) indicating the address of another terminal apparatus 12, server address information (such as an IP address and a MAC address, for example) indicating the address of the server 14, and the like. Additionally, the storage unit 36 stores terminal language setting information 38 and application language setting information 40.

The terminal language setting information 38 is information indicating the OS language setting of the terminal apparatus 12. For example, in the case in which the OS language of the terminal apparatus 12 is set to Japanese, the terminal language setting information 38 indicates Japanese.

The application language setting information 40 is information indicating the language setting of a piece of application software for operating a piece of equipment 10 installed in the terminal apparatus 12. For example, a piece of application software for each piece of equipment 10 is installed in the terminal apparatus 12, and a language is set for each piece of application software. Note that in the case in which a language is not set for application software, the application language setting information 40 does not have to be stored in the storage unit 36.

The control unit 42 is configured to control the operation of each unit of the terminal apparatus 12. For example, the control unit 42 executes programs, controls communication by the communication unit 32, controls the notification of information (such as the display and sound output of information, for example) using the UI unit 34, receives information input into the terminal apparatus 12 using the UI unit 34, writes information to the storage unit 36, reads out information from the storage unit 36, and the like. Also, the control unit 42 includes a language setting unit 44.

The language setting unit 44 is configured to set the language of the user interface of the terminal apparatus 12. The language setting unit 44 causes the storage unit 36 to store the terminal language setting information 38 indicating the OS language setting of the terminal apparatus 12, and causes the storage unit 36 to store the application language setting information 40 indicating the language setting of each piece of application software installed in the terminal apparatus 12. For example, in the case in which the user uses the UI unit 34 to designate the language of the terminal apparatus 12, the language setting unit 44 sets the language of the terminal apparatus 12 to the language designated by the user. In the case in which the user designates the OS language of the terminal apparatus 12, the language setting unit 44 causes the storage unit 36 to store the terminal language setting information 38 indicating the language designated by the user. In the case in which the user designates the language of a piece of application software, the language setting unit 44 sets the language of the piece of application software to the language designated by the user. In this case, the application language setting information 40 indicating the language designated by the user is stored in the storage unit 36.

In addition, in the case in which the language setting of a piece of equipment 10 that the terminal apparatus 12 itself has connected to is different from the language setting of the terminal apparatus 12 itself, the language setting unit 44 may change the language setting of the piece of equipment 10 to the language setting of the terminal apparatus 12 itself. For example, in the case in which the OS language setting of the terminal apparatus 12 itself is different from the OS language setting of the piece of equipment 10 that the terminal apparatus 12 itself has connected to, the language setting unit 44 changes the OS language of the piece of equipment 10 to the OS language setting of the terminal apparatus 12 itself. Also, in the case in which the terminal apparatus 12 itself has connected to a piece of equipment 10, and a piece of application software for operating the piece of equipment 10 is installed in the terminal apparatus 12 itself with a different language setting than the language setting of a piece of application software installed in the piece of equipment 10, the language setting unit 44 may change the language setting of the piece of application software installed in the piece of equipment 10 to the language setting of the piece of application software for operating the piece of equipment 10 installed in the terminal apparatus 12 itself.

For example, the control unit 42 expresses character strings displayed on the display of the UI unit 34 and expresses speech emitted from the speech output unit of the UI unit 34 in the language (that is, the OS language) indicated by the terminal language setting information 38. To describe by giving a specific example, in the case in which the language indicated by the terminal language setting information 38 is Japanese, the control unit 42 expresses character strings and speech in Japanese. For example, character strings displayed on a main screen, character strings displayed on a menu screen, character strings displayed on a settings screen, character strings displayed on an operating screen, various messages, file names, and folder names are expressed in Japanese. In the case in which the language of a piece of application software is not set, character strings displayed in association with the execution of the application software are expressed in the OS language, namely Japanese. The same also applies to speech.

Also, in the case in which the language of a piece of application software is set, when the application software is executed and a screen (such as a settings screen and an operating screen, for example) of the application software is displayed on the UI unit 34, the control unit 42 expresses character strings displayed on the screen in the language of the application software indicated by the application language setting information 40. For example, in the case in which the language set in the application software is English, the control unit 42 expresses character strings displayed on the screen in English. The same also applies to speech.

Hereinafter, the configuration of the server 14 will be described in detail with reference to FIG. 4. FIG. 4 illustrates an example of the configuration of the server 14.

The communication unit 46 is a communication interface, and includes a function of transmitting data to other apparatus, and a function of receiving data from other apparatus. The communication unit 46 may be a communication interface including a wireless communication function, or a communication interface including a wired communication function. For example, the communication unit 46 may support one or multiple types of communication schemes, and may communicate with a communication peer in accordance with a communication scheme suited to the communication peer (in other words, a communication scheme supported by the communication peer). For the communication schemes, the communication schemes described above are used, for example. The communication unit 46 may switch the communication scheme and frequency band depending on the communication peer, and may also switch the communication scheme and the frequency band depending on the surrounding environment.

The storage unit 48 is a storage apparatus such as a hard disk. The storage unit 48 stores various data, various programs, and the like, for example. The stored programs include an OS, various types of application software, various language data, and the like, for example. The storage unit 48 may also store equipment address information (such as an IP address and a MAC address, for example) indicating the address of a piece of equipment 10, terminal address information (such as an IP address and a MAC address, for example) indicating the address of the terminal apparatus 12, and the like. Additionally, the storage unit 48 may store the equipment language setting information 24 of each piece of equipment 10, the application language setting information 26 of each piece of equipment 10, the terminal language setting information 38 of the terminal apparatus 12, and the application language setting information 40 of the terminal apparatus 12.

The control unit 50 is configured to control the operation of each unit of the server 14. For example, the control unit 50 executes programs, controls communication by the communication unit 46, writes information to the storage unit 48, reads out information from the storage unit 48, and the like. Note that the server 14 may also be provided with a UI unit. In this case, the control unit 50 reports information using the UI unit, and receives information input into the server 14 using the UI unit. Also, the control unit 50 may include a language setting unit 52.

In the case in which the language setting of the terminal apparatus 12 that has connected to a piece of equipment 10 is different from the language setting of the piece of equipment 10, the language setting unit 52 is configured to change the language setting of the piece of equipment 10 to the language setting of the terminal apparatus 12. For example, in the case in which the OS language setting of the terminal apparatus 12 is different from the OS language setting of a piece of equipment 10, the language setting unit 52 changes the OS language of the piece of equipment 10 to the OS language setting of the terminal apparatus 12. Also, in the case in which the terminal apparatus 12 has connected to a piece of equipment 10, and a piece of application software for operating the piece of equipment 10 is installed in the terminal apparatus 12 with a different language setting than the language setting of a piece of application software installed in the piece of equipment 10, the language setting unit 52 may change the language setting of the piece of application software installed in the piece of equipment 10 to the language setting of the piece of application software for operating the piece of equipment 10 installed in the terminal apparatus 12.

The process of changing the language setting of a piece of equipment 10 to the language setting of the terminal apparatus 12 may be executed by the language setting unit 30 of the piece of equipment 10, by the language setting unit 44 of the terminal apparatus 12, or by the language setting unit 52 of the server 14. Note that in the case in which the process is executed by the piece of equipment 10 or the terminal apparatus 12, the language setting unit 52 does not have to be provided in the server 14, and the server 14 does not have to be used.

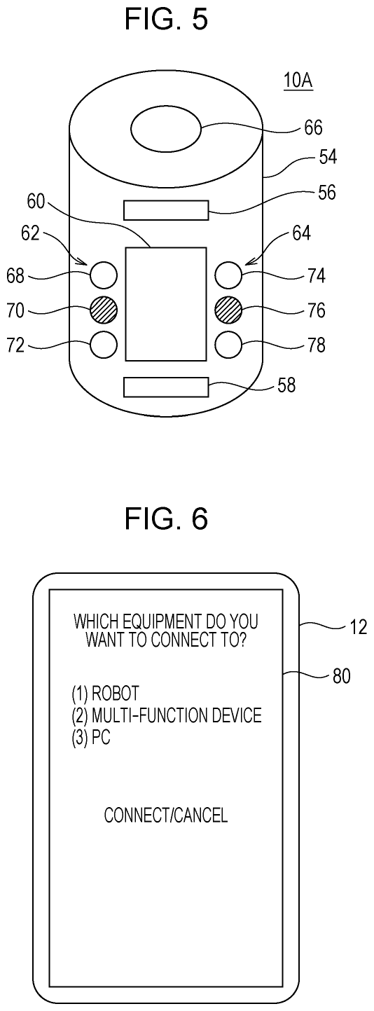

Hereinafter, the external appearance of a relay will be described in detail with reference to FIG. 5. FIG. 5 is a perspective view illustrating a relay. As an example, FIG. 5 illustrates the equipment 10A as the relay. The equipment 10E may include a configuration similar to the equipment 10A, or a different configuration.

The equipment 10A is what is called a smart speaker, and includes a communication function and a speech-based assistance function. The equipment 10A includes a columnar housing 54. On a side face of the housing 54, a microphone 56, a speaker 58, a display 60, and light-emitting sections 62 and 64 are provided. Also, on the top face of the housing 54, a sensor 66 is provided. Note that the shape of the housing 54 is not limited to the shape illumination in FIG. 5. Insofar as the relay is provided with the microphone 56 and the speaker 58, the shape may be any kind of shape. In addition, the microphone 56, the speaker 58, the display 60, the light-emitting sections 62 and 64, and the sensor 66 may also be disposed at positions other than the positions illustrated in FIG. 5.

The microphone 56 functions as a sound collection apparatus, and collects sound around the equipment 10A. For example, the voice of the user is collected by the microphone 56. For example, in the case in which a personal assistant having artificial intelligence (AI) is installed in the equipment 10A, content spoken by the personal assistant is emitted from the speaker 58. Additionally, music, television audio, radio audio, and the like may also be emitted from the speaker 58.

The display 60 is a display apparatus. The display 60 may also be a user interface (such as a touch panel, for example) that doubles as an operating unit.

The light-emitting section 62 includes one or multiple light sources (for example, light sources 68, 70, and 72), and emits light in accordance with a light emission method corresponding to the content of the settings for the personal assistant installed in the equipment 10A. For example, an age, gender, occupation, personality, and the like are set for the personal assistant as settings. The personal assistant obeys these settings to respond to the user and execute work. For example, in the case in which doctor is set as the occupation setting, the light sources 68 and 72 emit blue light, and the light source 70 emits yellow light. When a different setting is set, the light-emitting section 62 emits light in accordance with a light emission method corresponding to the set content.

The light-emitting section 64 includes one or multiple light sources (for example, light sources 74, 76, and 78), and emits light in accordance with a light emission method corresponding to the user account logged in to the personal assistant installed in the equipment 10A. For example, in the case in which a certain user is logged in to the personal assistant installed in the equipment 10A, the light sources 74 and 78 emit blue light, and the light source 76 emits yellow light. In the case in which a different user is logged in to the personal assistant, the light-emitting section 64 emits light in accordance with a light emission method corresponding to that user.

Note that the light-emitting sections 62 and 64 may also be provided on the housing 54 without being distinguished from each other. For example, all of the light sources included in the light-emitting sections 62 and 64 may be used to express the set content of the personal assistant and user accounts. In addition, the set content of the personal assistant and user accounts may also be expressed by the light emission pattern (such as the way and length of time in which the light blinks, for example) of each light source.

The sensor 66 detects a gesture by the user. The equipment 10A executes a process according to the detected gesture. For example, in accordance with a detected gesture, the equipment 10A may execute a process itself, or control the operation of another piece of equipment 10.

The piece of equipment 10A acting as a relay may control hardware included in another piece of equipment 10 connected to the relay, or control software installed in the other piece of equipment 10. Additionally, the equipment 10A may also acquire various types of information by utilizing the Internet or the like. The equipment 10A may also function as a server, manage data and user information, and the like. The equipment 10A may be installed indoors (such as on the floor or ceiling of a room or on a table, for example), or may installed outdoors. Also, the equipment 10A may be movable equipment (for example, automatic or self-moving equipment).

Hereinafter, operations of the information processing system according to the exemplary embodiment will be described in detail with reference to FIG. 1.

Herein, a case will be described in which the terminal apparatus 12 operated by the user connects to the equipment 10G that acts as a multi-function device. For example, in the case in which the user uses the UI unit 34 of the terminal apparatus 12 to give an instruction to connect to the equipment 10G, the terminal apparatus 12 transmits connection request information to the equipment 10G. The connection request information includes information requesting a connection between the terminal apparatus 12 and the equipment 10G, and the terminal language setting information 38 of the terminal apparatus 12. In addition, the connection request information may also include information indicating a process (such as a print job, for example) to be executed in the equipment 10G.

The equipment 10G receives the connection request information sent from the terminal apparatus 12, and establishes communication with the terminal apparatus 12. The language setting unit 30 of the equipment 10G compares the language indicated by the terminal language setting information 38 included in the connection request information (the OS language of the terminal apparatus 12) to the language indicated by the equipment language setting information 24 stored in the storage unit 22 of the equipment 10G (the OS language of the equipment 10G). In the case in which the languages are different, the language setting unit 30 changes the language setting of the equipment 10G to the language setting of the terminal apparatus 12. For example, the language setting unit 30 changes the OS language of the equipment 10G to the OS language of the terminal apparatus 12. For example, in the case in which the OS language of the equipment 10G is English and the OS language of the terminal apparatus 12 is Japanese, the language setting unit 30 changes the OS language of the equipment 10G from English to Japanese. The language setting unit 30 causes the storage unit 22 to store equipment language setting information 24 indicating the language after the change, namely Japanese, and the language before the change, namely English. The control unit 28 expresses character strings displayed on the UI unit 18 in the language after the change, namely Japanese. For example, character strings displayed on a main screen, a menu screen, an operating screen, and a settings screen of the multi-function device are expressed in Japanese. Also, speech emitted from the equipment 10G is expressed in Japanese.

In the case in which data for the language set in the terminal apparatus 12 (for example, Japanese data) is not currently stored in the equipment 10G, the terminal apparatus 12 may also provide the language data to the equipment 10G. For example, the control unit 28 of the equipment 10G transmits to the terminal apparatus 12 information indicating that the language data is not currently stored in the equipment 10G. The control unit 42 of the terminal apparatus 12 receives the information, and transmits the language data stored in the storage unit 36 of the terminal apparatus 12 to the equipment 10G. In the equipment 10G, by using the language data sent from the terminal apparatus 12, the language setting of the equipment 10G is changed to the language setting of the terminal apparatus 12.

As another example, in the case in which data for the language set in the terminal apparatus 12 (for example, Japanese data) is not currently stored in the equipment 10G, the control unit 28 of the equipment 10G may acquire the language data from an external apparatus storing the language data. For example, the control unit 28 of the equipment 10G downloads the language data from the external apparatus to the equipment 10G by utilizing the Internet or the like. By using the language data, the language setting of the equipment 10G is changed to the language setting of the terminal apparatus 12. In the case in which the language data is unavailable, the language setting of the equipment 10G is not changed. In this case, a message or the like indicated that the language has not been changed may be displayed on the terminal apparatus 12.

As yet another example, in the case in which data for the language set in the terminal apparatus 12 (for example, Japanese data) is not currently stored in the equipment 10G, information translated using the language may be provided to the equipment 10G, and the information may be displayed or emitted as speech from the equipment 10G. For example, the control unit 42 of the terminal apparatus 12 acquires information to be displayed on the equipment 10G expressed in the language set in the equipment 10G (for example, a character string expressed in English) from the equipment 10G, and translates the information into the language set in the terminal apparatus 12 (for example, Japanese). Next, the control unit 42 transmits the information translated into Japanese (for example, a character string translated into Japanese) to the equipment 10G. In the equipment 10G, the information translated into Japanese is displayed, emitted as speech, or the like. Additionally, the control unit 42 of the terminal apparatus 12 may also consecutively translate information to be displayed on the equipment 10G. In other words, the control unit 42 consecutively acquires information to be displayed on the equipment 10G from the equipment 10G, translates the information, and transmits translated information to the equipment 10G. With this arrangement, information to be displayed on the equipment 10G is translated consecutively, and the translated information is displayed. The same also applies to speech.

Note that the translation process may also be executed by the server 14. In this case, information indicating the language set in the terminal apparatus 12 and information to be displayed on the equipment 10G is transmitted to the server 14, and the information is translated into the language set in the terminal apparatus 12. Next, the translated information is transmitted from the server 14 to the equipment 10G, and the information is displayed on the equipment 10G, emitted as speech, or the like.

In the case in which the use of the equipment 10G through the terminal apparatus 12 has ended, the language setting unit 30 reverts the language setting of the equipment 10G back to the language setting before the change. In the above example, the language setting unit 30 changes the OS language of the equipment 10G from Japanese to English. The language setting unit 30 causes the storage unit 22 to store equipment language setting information 24 indicating English, and the control unit 28 expresses character strings to be displayed on the UI unit 18 in English. Speech emitted from the equipment 10G is also expressed in English. The case in which the use of the equipment 10G has ended refers to, for example, the case in which the user operating the terminal apparatus 12 has logged out of the equipment 10G, the case in which a process (such as a print job, for example) indicated by the user has ended, the case in which a timeout has occurred with respect to the use of the equipment 10G, or the like.

In the case in which the above languages are the same, the language setting unit 30 of the equipment 10G does not change the language setting of the equipment 10G.

The language setting of the equipment 10G may also be changed to the language setting of a piece of application software for operating the equipment 10G. In the terminal apparatus 12, a piece of application software for operating the equipment 10G is installed. In the case in which the piece of application software has been launched on the terminal apparatus 12, for example, an operating screen for operating the equipment 10G is displayed on the UI unit 34 of the terminal apparatus 12. Since the equipment 10G is a multi-function device, an operating screen for issuing execution instructions and adjusting settings of an image forming function and the like are displayed on the UI unit 34. Character strings displayed on the operating screen are expressed in the language of the application software. For example, if the language is Japanese, the character strings displayed on the operating screen are expressed in Japanese. Through this operating screen, the user is able to issue a request to connect to the equipment 10G and give execution instructions with respect to an image forming function such as a print function.

In the case in which the user issues an instruction to connect to the equipment 10G on the operating screen, the terminal apparatus 12 transmits connection request information to the equipment 10G. The connection request information includes information requesting a connection between the terminal apparatus 12 and the equipment 10G, and the application language setting information 40. The application language setting information 40 is information indicating the language of the piece of application software for operating the equipment 10G installed in the terminal apparatus 12. In addition, the connection request information may also include information indicating a process (such as a print job, for example) to be executed in the equipment 10G.

The equipment 10G receives the connection request information sent from the terminal apparatus 12, and establishes communication with the terminal apparatus 12. The language setting unit 30 of the equipment 10G compares the language indicated by the application language setting information 40 included in the connection request information (the language of the application software installed in the terminal apparatus 12) to the language indicated by the application language setting information 26 stored in the storage unit 22 of the equipment 10G (the language of the application software installed in the equipment 10G). In the case in which the languages are different, the language setting unit 30 changes the language setting of the application software installed in the equipment 10G to the language setting of the application software installed in the terminal apparatus 12. For example, in the case in which the language of the application software installed in the equipment 10G is English and the language of the application software installed in the terminal apparatus 12 is Japanese, the language setting unit 30 changes the language of the application software installed in the equipment 10G from English to Japanese. The language setting unit 30 causes the storage unit 22 to store application language setting information 26 indicating the language after the change, namely Japanese, and the language before the change, namely English. In the case in which the application software is executed and the UI unit 18 is displayed on the equipment 10G, the control unit 28 expresses character strings displayed on the screen in the language after the change, namely Japanese. In the case in which the use of the equipment 10G through the terminal apparatus 12 has ended, the language setting unit 30 reverts the language of the application software installed in the equipment 10G back to the language setting before the change (for example, English). The language setting unit 30 causes the storage unit 22 to store application language setting information 26 indicating English.

The language setting unit 30 of the equipment 10G may also compare the language indicated by the application language setting information 40 and the language indicated by the equipment language setting information 24 stored in the storage unit 22 of the equipment 10G (the OS language of the equipment 10G). In this case, if the languages are different, the language setting unit 30 changes the OS language of the equipment 10G to the language of the application software for operating the equipment 10G installed in the terminal apparatus 12. The language setting unit 30 causes the storage unit 22 to store equipment language setting information 24 indicating the language after the change, namely Japanese, and the language before the change, namely English. The control unit 28 expresses character strings displayed on the UI unit 18 in the language after the change, namely Japanese. Speech emitted from the equipment 10G is also expressed in Japanese. In the case in which the use of the equipment 10G through the terminal apparatus 12 has ended, the language setting unit 30 reverts the language setting of the equipment 10G back to the language setting before the change.

The language setting unit 44 of the terminal apparatus 12 may also change the language setting of the equipment 10G. In this case, the language setting unit 44 acquires the equipment language setting information 24 from the equipment 10G to connect to, and compare the language indicated by the terminal language setting information 38 (the OS language of the terminal apparatus 12) to the language indicated by the equipment language setting information 24 (the OS language of the equipment 10G). In the case in which the languages are different, the language setting unit 44 transmits the terminal language setting information 38 and information indicating a language-change instruction to the equipment 10G. The language setting unit 30 of the equipment 10G follows the language-change instruction, and changes the language setting of the equipment 10G to the language setting of the terminal apparatus 12. In other words, the language setting unit 30 changes the OS language of the equipment 10G to the language indicated by the terminal language setting information 38. In the case in which the languages are the same, the language setting unit 44 does not transmit information indicating a language-change instruction to the equipment 10G. Consequently, the language setting of the equipment 10G is not changed. In the case in which the language setting of the application software is changed, the change is also executed by a similar process.

In addition, the language setting unit 52 of the server 14 may also change the language setting of the equipment 10G. In this case, the terminal apparatus 12 transmits, to the server 14, the terminal language setting information 38 and equipment address information about the equipment 10G to connect to. The language setting unit 52 of the server 14 uses the equipment address information to access the equipment 10G, and acquires the equipment language setting information 24 from the equipment 10G. In the case in which the language indicated by the terminal language setting information 38 (the OS language of the terminal apparatus 12) and the language indicated by the equipment language setting information 24 (the OS language of the equipment 10G) are different, the language setting unit 52 transmits the terminal language setting information 38 and information indicating a language-change instruction to the equipment 10G. The language setting unit 30 of the equipment 10G follows the language-change instruction, and changes the language setting of the equipment 10G to the language setting of the terminal apparatus 12. In other words, the language setting unit 30 changes the OS language of the equipment 10G to the language indicated by the terminal language setting information 38. In the case in which the languages are the same, the language setting unit 52 does not transmit information indicating a language-change instruction to the equipment 10G. Consequently, the language setting of the equipment 10G is not changed. In the case in which the language setting of the application software is changed, the change is also executed by a similar process.

As above, according to the exemplary embodiment, in the case in which the language setting of a piece of equipment 10 that the terminal apparatus 12 has connected to is different from the language setting of the terminal apparatus 12 are different, the language setting of the piece of equipment 10 is changed to the language setting of the terminal apparatus 12. In this way, according to the present embodiment, the language setting of the piece of equipment 10 may be changed easily.

Hereinafter, exemplary modifications will be described.

(Exemplary Modification 1)

Hereinafter, Exemplary Modification 1 will be described. In Exemplary Modification 1, the language setting of another piece of equipment connected to a piece of equipment 10 that the terminal apparatus 12 has connected to is changed to the language setting of the terminal apparatus 12. Hereinafter, FIG. 1 will be referenced to describe Exemplary Modification 1 in detail.

For example, suppose that the pieces of equipment 10F, 10G, and 10H are connected to the piece of equipment 10E that acts as a relay. Herein, a case in which the terminal apparatus 12 connects to the equipment 10E is described. In the case in which a connection instruction is given by the user, the terminal apparatus 12 transmits connection request information to the equipment 10E. The connection request information includes information requesting a connection between the terminal apparatus 12 and the equipment 10E, and the terminal language setting information 38 of the terminal apparatus 12.

The equipment 10E receives the connection request information sent from the terminal apparatus 12, and establishes communication with the terminal apparatus 12. The language setting unit 30 of the equipment 10E compares the language indicated by the terminal language setting information 38 included in the connection request information (the OS language of the terminal apparatus 12) to the language indicated by the equipment language setting information 24 stored in the storage unit 22 of the equipment 10E (the OS language of the equipment 10E). In the case in which the languages are different, the language setting unit 30 of the equipment 10E changes the language setting of the equipment 10E to the language setting of the terminal apparatus 12. For example, the language setting unit 30 of the equipment 10E changes the OS language of the equipment 10E to the OS language of the terminal apparatus 12. With this arrangement, character strings displayed on the UI unit 18 of the equipment 10E and speech emitted from the equipment 10E are expressed in accordance with the language setting of the terminal apparatus 12. In the case in which the above languages are the same, the language setting unit 30 of the equipment 10E does not change the language setting of the equipment 10E.

Also, the language setting unit 30 of the equipment 10E transmits the above connection request information to the pieces of equipment 10F, 10G, and 10H connected to the equipment 10E. The language setting unit 30 of the equipment 10F compares the language indicated by the terminal language setting information 38 included in the connection request information to the language indicated by the equipment language setting information 24 stored in the storage unit 22 of the equipment 10F. In the case in which the languages are different, the language setting unit 30 of the equipment 10F changes the language setting of the equipment 10F to the language setting of the terminal apparatus 12. For example, the language setting unit 30 of the equipment 10F changes the OS language of the equipment 10F to the OS language of the terminal apparatus 12. With this arrangement, character strings displayed on the UI unit 18 of the equipment 10F and speech emitted from the equipment 10F are expressed in accordance with the language setting of the terminal apparatus 12. In the case in which the above languages are the same, the language setting unit 30 of the equipment 10F does not change the language setting of the equipment 10F. A similar process is also executed with respect to the pieces of equipment 10G and 10H.

According to Exemplary Modification 1, in the case in which yet another piece of equipment 10 is connected to the piece of equipment 10 that the terminal apparatus 12 has connected to, the language setting of the equipment 10 along with the language setting of the other piece of equipment 10 is made to match the language setting of the terminal apparatus 12. With this arrangement, the language settings of multiple pieces of equipment 10 may be changed easily.

In the above example, the language settings of all pieces of equipment 10 connected to the equipment 10E are changed to the language setting of the terminal apparatus 12, but the language settings of a subset of the equipment 10 may also be changed. For example, the language settings of equipment 10 selected by the user may also be changed. Hereinafter, FIG. 6 will be referenced to describe the language changing process in detail. FIG. 6 illustrates an example of a screen displayed on the terminal apparatus 12.

The screen 80 is a screen by which the user selects a piece of equipment 10 whose language setting is to be changed. For example, in the case in which the terminal apparatus 12 connects to the equipment 10E that acts as a relay, the equipment 10E transmits, to the terminal apparatus 12, equipment identification information (such as information indicating the equipment name, equipment ID, or equipment type, for example) for identifying each of the pieces of equipment 10F, 10G, and 10H connected to the equipment 10E. On the basis of the equipment identification information, the control unit 28 of the terminal apparatus 12 causes the display of the UI unit 34 to display the screen 80. On the screen 80, the names of each of the pieces of equipment 10F, 10G, and 10H connected to the equipment 10E are displayed. The robot is the piece of equipment 10F, the multi-function device is the piece of equipment 10G, and the PC is the piece of equipment 10H.

In the case in which the user selects a piece of equipment 10 to connect to and issues a connection instruction on the screen 80, the terminal apparatus 12 transmits information indicating the connection instruction to the equipment 10E. The equipment 10E transmits the information indicating the connection instruction to the piece of equipment 10 to connect to. With this arrangement, communication between the terminal apparatus 12 and the piece of equipment 10 to connect to is established through the equipment 10E that acts as a relay. For example, in the case in which the user selects the piece of equipment 10F that acts as a robot and issues a connection instruction, communication is established between the terminal apparatus 12 and the equipment 10F. Also, the terminal language setting information 38 is transmitted from the terminal apparatus 12 to the equipment 10F through the equipment 10E. In the case in which the language setting of the terminal apparatus 12 and the language setting of the equipment 10F are different, the language setting of the equipment 10F is changed to the language setting of the terminal apparatus 12.

In the case in which the language settings of the pieces of equipment 10E and 10F are different from the language setting of the terminal apparatus 12, the language settings of the pieces of equipment 10E and 10F are changed to the language setting of the terminal apparatus 12. For example, in the case in which the OS language of the terminal apparatus 12 is set to Japanese, the OS languages of the pieces of equipment 10E and 10F are set to Japanese. With this arrangement, the character strings displayed on the pieces of equipment 10E and 10F are expressed in Japanese. Speech emitted from the pieces of equipment 10E and 10F is also expressed in Japanese.

Note that in Exemplary Modification 1, the language setting of the equipment 10 may also be changed by the terminal apparatus 12 or the server 14. The same also applies to Exemplary Modification 2-5 described later.

(Exemplary Modification 2)

Hereinafter, Exemplary Modification 2 will be described. In Exemplary Modification 2, the language setting of a piece of equipment 10 connected to the terminal apparatus 12 is changed to the language setting of the terminal apparatus 12, according to a function executed using the piece of equipment 10. For example, if the user operates the UI unit 18 of the piece of equipment 10 in order to execute the function, the language setting of the piece of equipment 10 is changed to the language setting of the terminal apparatus 12, whereas if not, the language setting of the equipment 10 is not changed.

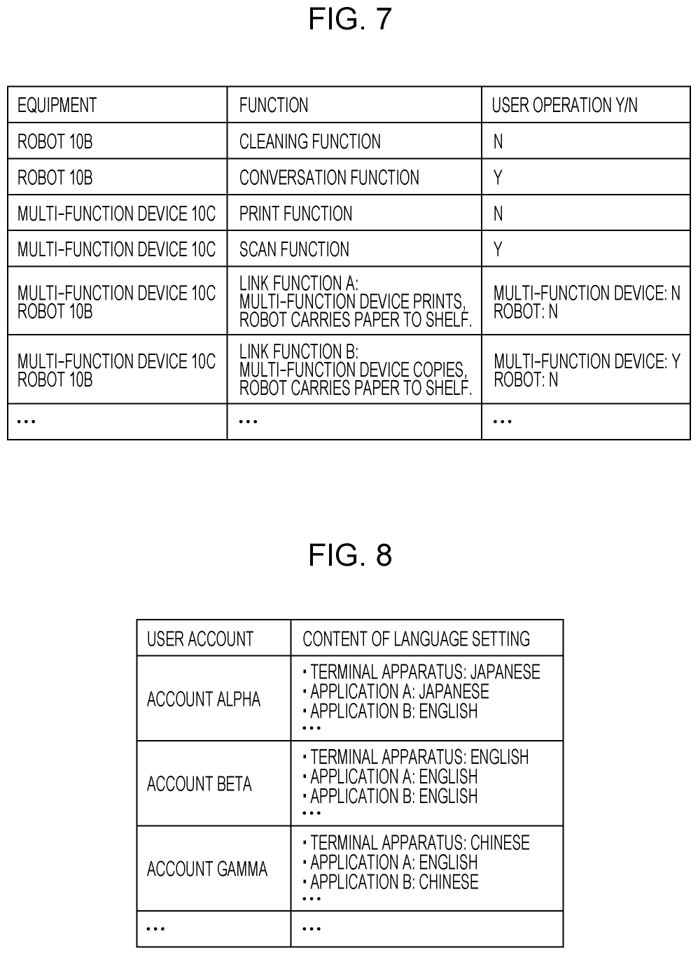

Hereinafter, FIG. 7 will be referenced to describe Exemplary Modification 2 in detail. FIG. 7 illustrates an example of an equipment management table. The equipment management table is a table indicating the functions included in each piece of equipment 10, or in other words, the contents of processes executable by each piece of equipment 10. Specifically, in the equipment management table, for each piece of equipment 10, identification information (such as a name, for example) about the piece of equipment 10, function information indicating a function included in the piece of equipment 10, and information indicating whether or not a user operation is performed in order to execute the function are associated with each other.

For example, the piece of equipment 10B that acts as a robot includes a function of cleaning the floor or the like, and a function of conversing with the user. The cleaning function is function that does not involve a user operation. In other words, the equipment 10B is able to execute the cleaning function without having the user operate the UI unit 18 of the equipment 10B. For example, even if the user does not operate the UI unit 18 of the equipment 10B, the equipment 10B is able to clean during a predetermined time period, or clean in response to unclean surroundings. On the other hand, the conversation function is a function that involves a user operation. In other words, in order for the equipment 10B to execute the conversation function, the user operates the UI unit 18 of the equipment 10B. For example, during a conversation with the equipment 10B, the user may input conversation content into the UI unit 18, operate the equipment 10B in accordance with information displayed on the UI unit 18, or perform a gesture operation or the like with respect to the UI unit 18.

Also, the piece of equipment 10C that acts as a multi-function device includes a print function and a scan function. The print function is function that does not involve a user operation. In other words, the equipment 10C is able to execute the print function without having the user operate the UI unit 18 of the equipment 10C. For example, by having the user use the terminal apparatus 12 to issue an instruction to execute the print function to the equipment 10C, the equipment 10C is able to execute the print function. On the other hand, the scan function is a function that involves a user operation. In other words, in order for the equipment 10C to execute the scan function, the user operates the UI unit 18 of the equipment 10C. For example, the user may input scan conditions or issue an instruction to start scanning on a screen displayed on the UI unit 18 of the equipment 10C.

In addition, the piece of equipment 10B that acts as a robot and the piece of equipment 10C that acts as a multi-function device are able to execute a link function A. The link function A is a function in which the piece of equipment 10C that acts as a multi-function device executes the print function, and the piece of equipment 10B that acts as a robot carries printed material (paper) generated by the printing to a shelf. The link function A is a function that does not involve a user operation. In other words, the pieces of equipment 10B and 10C are able to execute the link function A without having the user operate the UI unit 18 of each of the pieces of equipment 10B and 10C. For example, by having the user use the terminal apparatus 12 to issue an instruction to execute the link function A to the pieces of equipment 10B and 10C, the pieces of equipment 10B and 10C execute the link function A.

Additionally, the pieces of equipment 10B and 10C are able to execute a link function B. The link function B is a function in which the piece of equipment 10C that acts as a multi-function device executes the copy function, and the piece of equipment 10B that acts as a robot carries paper generated by the copying to a shelf. The link function B is a function that involves a user operation. In other words, the user does not operate the UI unit 18 of the equipment 10B, but does operate the UI unit 18 of the equipment 10C. For example, the user may input copy conditions or issue an instruction to start copying on a screen displayed on the UI unit 18 of the equipment 10C.

The functions illustrated in FIG. 7 are merely one example, and functions other than the above may also be set in each piece of equipment 10. Also, functions that use software may also be set.

The equipment management table is created in advance. The data of the equipment management table may be stored in the storage unit 36 of the terminal apparatus 12, stored in the storage unit 22 of each piece of equipment 10, or stored in the storage unit 48 of the server 14.

For example, in the case in which a piece of equipment 10 is registered in the terminal apparatus 12, information related to the piece of equipment 10 (identification information about the piece of equipment 10, function information, and information indicating whether or not a user operation is performed) is registered in the data of the equipment management table stored in the terminal apparatus 12. Every time a new piece of equipment 10 is registered in the terminal apparatus 12, information related to the new piece of equipment 10 is registered in the equipment management table. The case in which the data of the equipment management table is stored in the server 14 is also similar, and when a piece of equipment 10 is registered in the server 14, information related to the piece of equipment 10 is registered in the data of the equipment management table stored in the server 14. In addition, the data of the equipment management table may be stored in a piece of equipment 10 that acts as a relay, and information related to another piece of equipment 10 connected to the relay may be registered in the equipment management table. Also, each piece of equipment 10 may share information related to itself with the other pieces of equipment 10.

For example, in the case in which the terminal apparatus 12 transmits information indicating an instruction to execute the cleaning function to the equipment 10B, since the cleaning function does not involve a user operation, the language setting unit 30 of the equipment 10B does not change the language setting of the equipment 10B.

On the other hand, in the case in which the terminal apparatus 12 transmits information indicating an instruction to execute the conversation function to the equipment 10B, since the conversation function involves a user operation, the language setting unit 30 changes the language setting of the equipment 10B to the language setting of the terminal apparatus 12.

Also, in the case in which the terminal apparatus 12 transmits information indicating an instruction to execute the link function A to the pieces of equipment 10B and 10C, since the link function A does not involve a user operation, the language setting unit 30 of the equipment 10B does not change the language setting of the equipment 10B, and the language setting unit 30 of the equipment 10C does not change the language setting of the equipment 10C.

On the other hand, in the case in which the terminal apparatus 12 transmits information indicating an instruction to execute the link function B to the pieces of equipment 10B and 10C, since the link function B involves a user operation with respect to the equipment 10C, the language setting unit 30 of the equipment 10C changes the language setting of the equipment 10C to the language setting of the terminal apparatus 12. Since the link function B does not involve a user operation with respect to the equipment 10B, the language setting unit 30 of the equipment 10B does not change the language setting of the equipment 10B.

As above, according to Exemplary Modification 2, the language setting of the equipment 10 is changed depending on the function to be executed. In other words, if the function involves a user operation with respect to the UI unit 18 of a piece of equipment 10, the language setting of that piece of equipment 10 is changed to the language setting of the terminal apparatus 12. In this way, the language setting of a piece of equipment 10 potentially operated by the user may be changed easily.

(Exemplary Modification 3)

Hereinafter, Exemplary Modification 3 will be described. In Exemplary Modification 3, a language is set for each user. For example, the same terminal apparatus 12 may be used by multiple users in some cases. In these cases, when a certain user logs in to the terminal apparatus 12, a language associated with the user may be used as the language of the UI unit 34 of the terminal apparatus 12, whereas when a different user logs in to the terminal apparatus 12, a language associated with the different user may be used as the language of the UI unit 34. In this way, in the case in which a language is set for each user, the language setting of the equipment 10 is also controlled in accordance with the language setting for each user.

Hereinafter, FIG. 8 will be referenced to describe Exemplary Modification 3 in detail. FIG. 8 illustrates an example of a user management table. The user management table is a table for managing language settings for each user account. Specifically, in the user management table, for each user account, the user account and information indicating the contents of language settings are associated with each other. For example, information indicating the content of the OS language setting of the terminal apparatus 12 and information indicating the content of the language settings of applications for operating the equipment 10 installed in the terminal apparatus 12 are registered in the user management table. Note that multiple different user accounts may also be assigned to the same user.

For example, the OS language of the terminal apparatus 12 and the languages of application software A, B, and the like are set as languages associated with Account Alpha. The application software A is a piece of application software for operating the equipment 10A. The application software B is a piece of application software for operating the equipment 10B. Japanese is set as the OS language of the terminal apparatus 12. Japanese is set as the language of the application software A. English is set as the language of the application software B.

In addition, the OS language of the terminal apparatus 12 and the languages of the application software A, B, and the like are set as languages associated with Account Beta. English is set as the OS language of the terminal apparatus 12. English is set as the language of the application software A and B.

In addition, the OS language of the terminal apparatus 12 and the languages of the application software A, B, and the like are set as languages associated with Account Gamma. Chinese is set as the OS language of the terminal apparatus 12. English is set as the language of the application software A. Chinese is set as the language of the application software B.

The data of the user management table is stored in the storage unit 36 of the terminal apparatus 12. By using the terminal apparatus 12, a new account may be created. In the case in which a language associated with the account is set, the content of the setting is registered in the user management table. Note that the data of the user management table may also be stored in the storage unit 36 as an example of the terminal language setting information 38 and the application language setting information 40.

For example, in the case in which the user associated with Account Alpha logs in to the terminal apparatus 12, the control unit 42 sets the language of the UI unit 34 to Japanese. For example, character strings displayed on the UI unit 34 are expressed in Japanese, and speech emitted from the UI unit 34 is expressed in Japanese. Also, in the case in which the application software A is launched on the terminal apparatus 12, and a screen of the application software A is displayed on the UI unit 34, the control unit 42 sets the language of the screen to Japanese. For example, character strings displayed on the screen are expressed in Japanese. Speech may also be expressed in Japanese. Also, in the case in which the application software B is launched on the terminal apparatus 12, and a screen of the application software B is displayed on the UI unit 34, the control unit 42 sets the language of the screen to English. For example, character strings displayed on the screen are expressed in English. Speech may also be expressed in English.

Also, in the case in which the user associated with Account Beta logs in to the terminal apparatus 12, the control unit 42 sets the language of the UI unit 34 to English. For example, character strings displayed on the UI unit 34 are expressed in English, and speech emitted from the UI unit 34 is expressed in English. Also, in the case in which the application software A is launched on the terminal apparatus 12, and a screen of the application software A is displayed on the UI unit 34, the control unit 42 sets the language of the screen to English. For example, character strings displayed on the screen are expressed in English. Speech may also be expressed in English. The same applies to the case in which the application software B is launched.

In the case in which the user associated with Account Gamma logs in to the terminal apparatus 12, languages are set similarly to the above.

Note that in the case in which a user associated with a specific account is not logged in to the terminal apparatus 12, a predetermined common language is used as the language of the UI unit 34.

For example, suppose that the user associated with Account Alpha is logged in to the terminal apparatus 12, and the terminal apparatus 12 is connected to the equipment 10A. In this case, information indicating the language setting associated with Account Alpha is transmitted from the terminal apparatus 12 to the equipment 10A. In the case in which the language setting of the terminal apparatus 12 and the language setting associated with Account Alpha are different, the language setting unit 30 of the equipment 10A changes the language setting of the equipment 10A to the language setting associated with Account Alpha. For example, in the case in which the OS language of the equipment 10A is set to English, the language setting unit 30 of the equipment 10A changes the OS language of the equipment 10A to the OS language of the terminal apparatus 12, namely Japanese. By such an arrangement, when the user associated with Account Alpha uses the equipment 10A, the language of the UI unit 18 of the equipment 10A is set to Japanese. Also, the language setting unit 30 of the equipment 10A may also change the OS language of the equipment 10A or the language of the application software A installed in the equipment 10A to the language of the application software A installed in the terminal apparatus 12, namely Japanese.

In the case in which a process assigned to the equipment 10A by the user associated with Account Alpha is completed, in the case in which the user logs out of the equipment 10A, in the case in which the user logs out of the terminal apparatus 12, in the case in which a timeout occurs, or the like, the language setting unit 30 of the equipment 10A reverts the language setting of the equipment 10A back to the language setting before the change.

Also, in the case in which the user associated with Account Beta is logged in to the terminal apparatus 12, and the terminal apparatus 12 is connected to the equipment 10A, the language setting of the equipment 10A is controlled in accordance with the language setting associated with Account Beta. For example, in the case in which the OS language of the equipment 10A is set to English, since the language setting associated with Account Beta and the language setting of the equipment 10A are the same, the language setting unit 30 of the equipment 10A does not change the language setting of the equipment 10A. By such an arrangement, when the user associated with Account Beta uses the equipment 10A, the language of the UI unit 18 of the equipment 10A is set to English.

According to Exemplary Modification 3, the language setting of the equipment 10 is changed depending on the user account logged in to the terminal apparatus 12. With this arrangement, languages suited to individual users are used.

The language setting unit 30 may also prioritize the language setting of a piece of application software over the OS language setting of the terminal apparatus 12 to change the language setting of the equipment 10. For example, in the case in which the OS language of the terminal apparatus 12 and the language of a piece of application software installed in the terminal apparatus 12 are different, the language setting unit 30 sets the language of the equipment 10 to the language of the application software.

For example, suppose that the user associated with Account Gamma logs in to the terminal apparatus 12, and the terminal apparatus 12 is connected to the equipment 10A. With regard to Account Gamma, the OS language of the terminal apparatus 12 is set to Chinese, and the language of the application software A installed in the terminal apparatus 12 is set to English. For example, in the case in which Japanese is set as the OS language of the equipment 10A, the language setting unit 30 of the equipment 10A changes the OS language of the equipment 10A to the language of the application software A installed in the terminal apparatus 12, namely English. With such an arrangement, character strings displayed on the UI unit 18 of the equipment 10A are expressed in accordance with the language of the application software A for operating the equipment 10A, namely English. The language setting unit 30 may also set the language of the application software A installed in the equipment 10A to English.

Note that even in the case in which a language is not set for each user account, the language setting unit 30 may prioritize the language setting of a piece of application software over the OS language setting of the terminal apparatus 12 to change the language setting of the equipment 10. In other words, this process may also be applied to examples other than Exemplary Modification 3.

(Exemplary Modification 4)

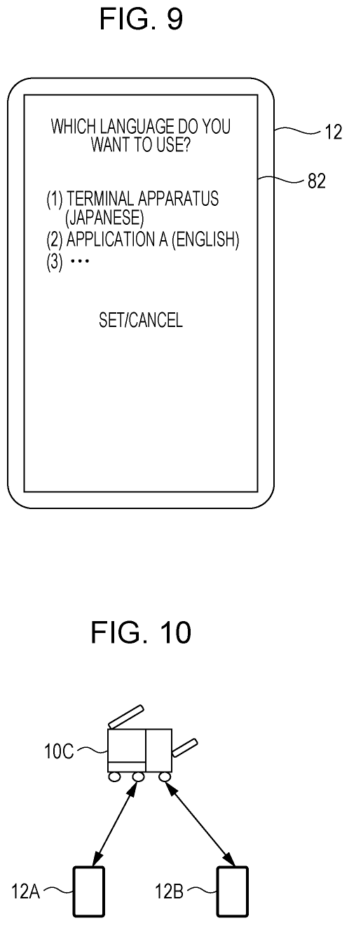

Hereinafter, Exemplary Modification 4 will be described in detail. In Exemplary Modification 4, a screen by which the user selects the OS language setting of the terminal apparatus 12 or the language setting of a piece of application software as the language setting of the equipment 10 is displayed on the UI unit 34 of the terminal apparatus 12. FIG. 9 illustrates an example of the screen.

For example, in the case in which the terminal apparatus 12 is connected to a piece of equipment 10, the control unit 42 of the terminal apparatus 12 causes the UI unit 34 to display a screen 82. On the screen 82, information indicating the OS language of the terminal apparatus 12 and information indicating the language of a piece of application software for operating the piece of equipment 10 installed in the terminal apparatus 12 is displayed. For example, suppose that the OS language of the terminal apparatus 12 is set to Japanese and the language of the application software A for operating the piece of equipment 10 is set to English. In this case, information indicating these languages is displayed on the screen 82.

In the case in which the user selects a language and gives an instruction to set the language on the screen 82, information indicating the language selected by the user is transmitted from the terminal apparatus 12 to the equipment 10. The language setting unit 30 of the equipment 10 changes the language of the equipment 10 to the language selected by the user. The OS language of the equipment 10 may be changed, or the language of the application software for operating the equipment 10 may be changed. For example, in the case in which the user has selected Japanese, the language of the equipment 10 is set to Japanese.

According to Exemplary Modification 4, in the case in which the OS language of the terminal apparatus 12 and the language of the application software installed in the terminal apparatus 12 are set, a language selected by the user is set as the language of the equipment 10.

(Exemplary Modification 5)

Hereinafter, FIG. 10 will be referenced to describe Exemplary Modification 5. FIG. 10 illustrates a piece of equipment 10C that acts as a multi-function device, and terminal apparatus 12A and 12B. The terminal apparatus 12A and 12B have the same configuration as the terminal apparatus 12.

As one example, suppose that the language set in the equipment 10C is English, the language set in the terminal apparatus 12A is Japanese, and the language set in the terminal apparatus 12B is Chinese.

In the case in which the terminal apparatus 12A connects to the equipment 10C, similarly to the exemplary embodiment described earlier, the language setting of the equipment 10C is changed to the language setting of the terminal apparatus 12A. Herein, the language of the equipment 10C is set to Japanese. With this arrangement, character strings expressed in Japanese are displayed on the equipment 10C, and speech expressed in Japanese is emitted from the equipment 10C.

Suppose that while User A of the terminal apparatus 12A is using the equipment 10C, the terminal apparatus 12B connects to the equipment 10C. In the case in which the original language setting of the equipment 10C (for example, English) and the language setting of the terminal apparatus 12B are different, the language setting unit 30 of the equipment 10C changes the language setting of the equipment 10C to the language setting of the terminal apparatus 12B after User A finishes using the equipment 10C. For example, after the use of the equipment 10C through the terminal apparatus 12A ends, after the execution of a process assigned to the equipment 10C through the terminal apparatus 12A is completed, after the execution of a process given directly to the equipment 10C by User A, after User A logs out of the equipment 10C, or after a timeout occurs, the language setting unit 30 changes the language setting of the equipment 10C to the language setting of the terminal apparatus 12B.

In the above example, after User A finishes using the equipment 10C, the language setting unit 30 sets the language of the equipment 10C to Chinese. With this arrangement, character strings expressed in Chinese are displayed on the equipment 10C, and speech expressed in Chinese is emitted from the equipment 10C.

According to Exemplary Modification 5, even in the case in which multiple terminal apparatus 12 connect to a piece of equipment 10, a language suited to each terminal apparatus 12 is set in the equipment 10.

In Exemplary Modification 5, data for the language set in the terminal apparatus 12B (for example, Chinese data) may not be currently stored in the equipment 10C in some cases. In this case, while User A of the terminal apparatus 12A is using the equipment 10C, the control unit 42 of the terminal apparatus 12B may acquire information reported when User B of the terminal apparatus 12B uses the equipment 10C, translate the information into the language set in the terminal apparatus 12B (for example, Chinese), and transmit the translated information to the equipment 10C. After User A finishes using the equipment 10C, the translated information (for example, character strings translated into Chinese) is displayed on the equipment 10C, or the translated speech (for example, speech translated into Chinese) is emitted from the equipment 10C.

For example, the control unit 42 of the terminal apparatus 12B acquires information displayed on the main screen of the equipment 10C from the equipment 10C, translates the information into Chinese, and transmits the translated information to the equipment 10C. With this arrangement, after User A finishes using the equipment 10C, the main screen translated into Chinese is displayed on the equipment 10C. The same also applies to speech.

Additionally, the control unit 42 of the terminal apparatus 12B may also translate into Chinese the information displayed on each screen related to each function included in the equipment 10C. With this arrangement, when User B uses the equipment 10C, each screen translated into Chinese is displayed on the equipment 10C. The same also applies to speech.

Also, in the case in which User B of the terminal apparatus 12B designates a function of the equipment 10C on the terminal apparatus 12B, the control unit 42 of the terminal apparatus 12B may translate information displayed on the equipment 10C in relation to the designated function (for example, information displayed on a settings screen) into Chinese. The above will be described by citing a specific example. In the case in which User B designates, on the terminal apparatus 12B, the print function of the equipment 10C as a function to be executed, the control unit 42 of the terminal apparatus 12B acquires information displayed on the equipment 10C in relation to the print function (for example, information displayed on a print settings screen) from the equipment 10C, translates the information into Chinese, and transmits the information translated into Chinese to the equipment 10C. With this arrangement, after User A finishes using the equipment 10C, the print settings screen translated into Chinese is displayed on the equipment 10C. The same also applies to speech.

As above, by translating while another user is using a piece of equipment 10, compared to the case of starting translation after the other user finishes using the piece of equipment 10, translated information is provided at an earlier stage after the other user finishes using the piece of equipment 10.

(Exemplary Modification 6)

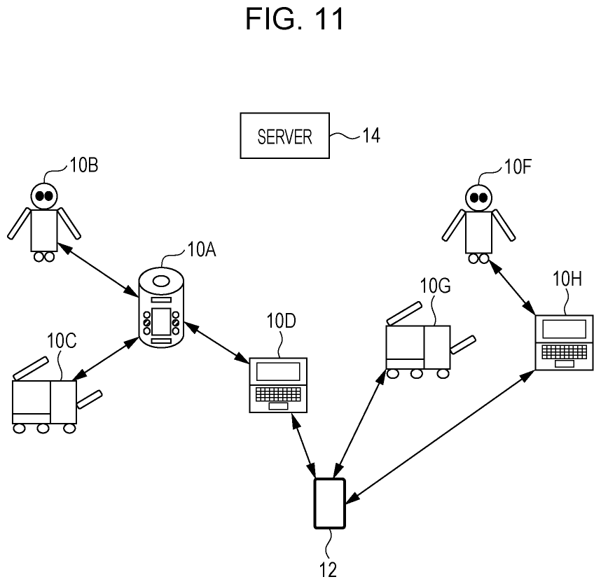

Hereinafter, Exemplary Modification 6 will be described. In Exemplary Modification 6, in the case in which the terminal apparatus 12 connects to multiple pieces of equipment 10, the language setting of one or more pieces of equipment 10 whose language setting is different from the language setting of the terminal apparatus 12 from among the multiple pieces of equipment 10 is changed to the language setting of the terminal apparatus 12. Hereinafter, FIG. 11 will be referenced to describe Exemplary Modification 6 in detail. FIG. 11 illustrates an example of the information processing system according to Exemplary Modification 6.

The pieces of equipment 10A, 10B, 10C, and 10D are installed in Japan, while the pieces of equipment 10F, 10G, and 10H are installed in the United States of America. In the example illustrated in FIG. 11, the equipment 10E that acts as a relay is not used.

For example, suppose that the terminal apparatus 12 is connected to the pieces of equipment 10D, 10F, 10G, and 10H simultaneously, without going through the pieces of equipment 10A and 10E that act as relays. Specifically, the terminal apparatus 12 is connected to the pieces of equipment 10D, 10G, and 10H directly, and is connected to the piece of equipment 10F through the piece of equipment 10H. Note that in the simultaneous connection herein, the timings at which terminal apparatus 12 connects to each piece of equipment 10 may or may not coincide exactly. For example, the start times of the connections to each piece of equipment 10 may coincide, the end times of the connections to each piece of equipment 10 may coincide, the connection periods may overlap without the start times of the connections to each piece of equipment 10 coinciding, or the connection periods may overlap without the end times of the connections to each piece of equipment 10 coinciding. Obviously, depending on the processing speed and the communication environment, differences may occur in the connection start time and end time for each piece of equipment 10 in some cases. For example, the terminal apparatus 12 may transmit information indicating a connection request to each piece of equipment 10 simultaneously, and as a result, the terminal apparatus 12 may be connected to each piece of equipment 10 exactly simultaneously, or the terminal apparatus 12 may be connected to each piece of equipment 10 with a time difference occurring for each piece of equipment 10.

For example, suppose that the languages of the piece of equipment 10D and the terminal apparatus 12 are set to Japanese, while the languages of the pieces of equipment 10F, 10G, and 10H are set to English. In this case, the language settings of the pieces of equipment 10F, 10G, and 10H are changed to the language setting of the terminal apparatus 12. In other words, the languages of the pieces of equipment 10F, 10G, and 10H are set to Japanese. Since the language settings of the piece of equipment 10D and the terminal apparatus 12 are the same, the language setting of the piece of equipment 10D is not changed. In this way, in the case in which the terminal apparatus 12 connects to multiple pieces of equipment 10, there may be a mixture of equipment 10 whose language setting is changed and equipment 10 whose language setting is not changed. In other words, whether or not to change the language setting is decided individually for each piece of equipment 10.

The changing of the language setting may be executed by the language setting unit 30 of each piece of equipment 10, by the language setting unit 44 of the terminal apparatus 12, or by the language setting unit 52 of the server 14.

According to Exemplary Modification 6, in the case in which the terminal apparatus 12 connects to multiple pieces of equipment 10, if there exists a piece of equipment 10 whose language setting is different from the language setting of the terminal apparatus 12 from among the multiple pieces of equipment 10, the language setting of the piece of equipment 10 is changed to the language setting of the terminal apparatus 12. In this way, even in the case in which the terminal apparatus 12 connects to multiple pieces of equipment 10, the language setting of the equipment 10 may be changed easily.

The exemplary embodiments and exemplary modifications described above may be used in the examples given below. For example, in the case in which a portable music player is connected to a speaker physically, wirelessly, or the like, the language setting of the speaker is changed to the language setting of the music player. For example, information displayed on a screen of the speaker is changed to the language of the music player. The same also applies to speech emitted from the speaker. In this example, the music player functions as the terminal apparatus 12, while the speaker functions as the equipment 10.

In the exemplary embodiments and exemplary modifications described above, in the case in which pieces of equipment 10 are connected to each other, the language setting of the equipment 10 may be changed. For example, information indicating a connection request may be transmitted from a certain piece of equipment 10 to another piece of equipment 10, and in the case in which the certain piece of equipment 10 connects to the other piece of equipment 10, the language setting of the other piece of equipment 10 may be changed to the language setting of the certain piece of equipment 10.

Note that in the case in which it is customary to use a specific language, the language of the equipment 10 may be changed to the specific language. For example, in the case in which the use of English is customary in a specific field of technology, the language of a piece of equipment 10 used with the technology may be changed to English.

Each of the equipment 10, the terminal apparatus 12, and the server 14 above is realized by cooperation between hardware and software as an example. Specifically, each of the equipment 10, the terminal apparatus 12, and the server 14 is provided with one or multiple processors such as CPUs (not illustrated). By having the one or multiple processors load and execute a program stored in a storage apparatus (not illustrated), the functions of each unit of the equipment 10 are realized. The above program is stored in the storage apparatus via a recording medium such as a CD or DVD, or alternatively, via a communication link such as a network. As another example, the respective units of each of the equipment 10, the terminal apparatus 12, and the server 14 may be realized by hardware resources such as a processor, an electronic circuit, or an application-specific integrated circuit (ASIC), for example. A device such as memory may also be used in such a realization. As yet another example, the respective units of each of the equipment 10, the terminal apparatus 12, and the server 14 may also be realized by a digital signal processor (DSP), a field-programmable gate array (FPGA), or the like.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An information processing apparatus comprising:
a controller that, in a case in which a language setting of a terminal operated by a user and a language setting of a piece of equipment used by being connected to the terminal are different, changes the language of the piece of equipment to the language setting of the terminal.

2. The information processing apparatus according to claim 1, wherein
the language setting of the terminal is changeable by an operation by the user.

3. The information processing apparatus according to claim 1, wherein
the piece of equipment is equipment that includes a user interface.

4. The information processing apparatus according to claim 3, wherein
the user interface includes a display, and
the language setting of the piece of equipment is a language setting for expressing information displayed on the display.

5. The information processing apparatus according to claim 3, wherein
the user interface includes a speech output unit, and
the language setting of the piece of equipment is a language setting for expressing speech emitted from the speech output unit.

6. The information processing apparatus according to claim 1, wherein
the controller additionally changes the language setting of an other piece of equipment connected to the piece of equipment to the language setting of the terminal.

7. The information processing apparatus according to claim 6, wherein
piece of equipment whose language setting is changed.

8. The information processing apparatus according to claim 1, wherein
the controller additionally changes the language setting of the piece of equipment to the language setting of the terminal according to a function executed by using the piece of equipment connected to the terminal.

9. The information processing apparatus according to claim 8, wherein
in a case in which an execution of the function involves an operation by the user on the piece of equipment, the controller changes the language setting of the piece of equipment to the language setting of the terminal.

10. The information processing apparatus according to claim 1, wherein
the language setting of the terminal is a language setting of software for operating the piece of equipment.

11. The information processing apparatus according to claim 10, wherein
the language setting of the software is a per-user language setting.

12. The information processing apparatus according to claim 1, wherein
the language setting of the terminal is a language setting of the terminal itself.

13. The information processing apparatus according to claim 12, wherein
the language setting of the terminal itself is a per-user language setting.

14. The information processing apparatus according to claim 1, wherein
the controller additionally changes the language setting of the piece of equipment by prioritizing a use of a language setting of software for operating the piece of equipment over a language setting of the terminal itself as the language setting of the terminal.

15. The information processing apparatus according to claim 1, wherein
the controller additionally controls a notification of information by which the user selects a language setting of software for operating the piece of equipment or a language setting of the terminal itself as the language setting of the piece of equipment.

16. The information processing apparatus according to claim 1, wherein
the controller additionally reverts the language setting of the piece of equipment back to the setting before the change in a case in which the use of the piece of equipment ends.

17. The information processing apparatus according to claim 1, wherein
in a case in which data for a language set in the terminal does not exist in the piece of equipment, the terminal provides data for the language to the piece of equipment.

18. The information processing apparatus according to claim 1, wherein
in a case in which data for a language set in the terminal does not exist in the piece of equipment, the piece of equipment acquires data for the language from an external apparatus.

19. The information processing apparatus according to claim 1, wherein
in a case in which data for a language set in the terminal does not exist in the piece of equipment, the controller additionally provides the piece of equipment with information obtained by translating information to be reported on the piece of equipment into the language set in the terminal.

20. The information processing apparatus according to claim 1, wherein
after the language setting of the piece of equipment is changed to the language setting of the terminal, in a case in which an other terminal connects to the piece of equipment, and the language setting of the piece of equipment is different from the language setting of the other terminal, the controller changes the language setting of the piece of equipment to the language setting of the other terminal after the use of the piece of equipment through the terminal connected to the piece of equipment earlier ends.

21. The information processing apparatus according to claim 20, wherein
in a case in which information about the language set in the other terminal does not exist in the piece of equipment, while the piece of equipment is being used through the terminal connected to the piece of equipment earlier, the controller additionally translates information to be reported on the piece of equipment when the piece of equipment is used through the other terminal into the language set in the other terminal, and provides translated information to the piece of equipment.

22. The information processing apparatus according to claim 1, wherein
in a case in which the terminal connects to a plurality of pieces of equipment, the controller changes the language setting of equipment whose language setting is different from the language setting of the terminal from among the plurality of pieces of equipment to the language setting of the terminal.

23. An information processing apparatus comprising:
a controller that, in a case in which a language setting of the information processing apparatus itself operated by a user and a language setting of a piece of equipment used by being connected to the information processing apparatus are different, changes the language of the piece of equipment to the language setting of the information processing apparatus itself.

24.-27. (canceled)
